(19) United States
(12) Patent Application Publication
(10) Pub. No.: US 2011/0319209 A1
(43) Pub. Date: Dec. 29, 2011

(54) INTEGRATED BICYCLE CHAINRING ASSEMBLY

(75) Inventors: Jin Yi Huang, Huatan Township (TW); Chin Tai Chuang, Dacun Township (TW)

(73) Assignee: TWDT Precision Co., Ltd., Huatan Township (TW)

(21) Appl. No.: 13/171,264

(22) Filed: Jun. 28, 2011

Related U.S. Application Data
(60) Provisional application No. 61/359,253, filed on Jun. 28, 2010.

(51) Int. Cl. B62M 9/00; B21K 1/28; F16H 55/30

(52) U.S. Cl. 474/164; 29/893.3

(57) ABSTRACT

An improved bicycle chainring assembly. The improved assembly includes at least two integrally formed chainrings configured to be attached to a bicycle crankarm via mounting apertures formed in the assembly. The chainrings of the assembly may be joined with discrete, continuous, or semi-continuous connection structures to achieve any desired degree of stiffness and weight savings. In some cases, the mounting apertures may be formed near the periphery of one of the chainrings.

The pedals of a bicycle are generally attached to crankarms on opposite sides of the bicycle frame. The crankarms are typically joined together by a spindle that passes through the frame, rigidly attaching the crankarms at positions that are rotated by 180 degrees relative to each other. This allows the alternating pedaling motion with which all bicycle riders are familiar. Accordingly, bicycles require a bearing assembly to allow for the rotation of the spindle and attached crankarms relative to the frame. This bearing assembly is commonly known as a bottom bracket, and the portion of the bicycle frame through which the assembly passes is commonly known as the bottom bracket shell of the frame.

A rider's pedaling action is generally transformed into motion of the bicycle through a multi-component drive train. A bicycle drive train typically includes one or more front chainrings attached to the crankarms. The chainrings are coupled through a chain to one or more rear cogs, which are in turn coupled to a hub of the rear wheel of the bicycle. Thus, forward pedaling motion causes forward rotation of the chainrings, which causes movement of the chain. The moving chain causes forward rotation of the rear cogs, which causes rotation of the rear wheel and propels the bicycle forward.

Conventional bicycle chainring assemblies typically include two or more separate discrete rings of different sizes, which are assembled together and attached to the crankarms. In a common mounting arrangement, two chainrings are attached to the crankarms with a plurality of mounting bolts (typically four or five), which also serve to attach the chainrings to each other. When a third chainring is used, it is typically attached separately to the crankarms. Regardless of whether two or three chainrings are used, this conventional mounting arrangement has several disadvantages.

First, because the chainrings are each attached directly to the crankarms, the maximum possible diameter of the bottom bracket bearing is limited to less than the diameter defined by the crankarm mounting points for the smallest chainring. In some cases, a larger bottom bracket diameter may be desirable to increase lateral stiffness and make power transfer between the two sides of the crankarm more efficient. In addition, the mounting hardware required for individual mounting of each chainring to the crankarms can be undesirably heavy, resulting in a heavier overall bicycle. Furthermore, chainring shifting performance is related to the stiffness of the chainring assembly, and this stiffness is limited in conventional mounting arrangements by the limited number of locations at which the chainrings are attached to each other. Finally, manufacturing chainrings individually may be undesirably labor-intensive and expensive.

Accordingly, there is a need for an improved bicycle chainring assembly that overcomes some or all of the shortcomings of conventional assemblies.

### SUMMARY

The present disclosure relates to an improved bicycle chainring assembly. The improved assembly includes at least two integrally formed chainrings configured to be attached to a bicycle crankarm via mounting apertures formed in the assembly. The chainrings may be joined with discrete, continuous, or semi-continuous connection structures to achieve any desired degree of stiffness and weight savings. In some cases, the mounting apertures may be formed near the periphery of one of the chainrings.

### BRIEF DESCRIPTION OF THE DRAWINGS

FIG. 1 is a top view depicting one embodiment of an improved bicycle chainring assembly, according to aspects of the present teachings.

FIG. 2 is an isometric view of the chainring assembly of FIG. 1.

FIG. 3 is a top view depicting another embodiment of an improved bicycle chainring assembly, according to aspects of the present teachings.

FIG. 4 is an isometric view of the chainring assembly of FIG. 3.

FIG. 5 is an isometric depicting yet another embodiment of an improved bicycle chainring assembly, according to aspects of the present teachings.

FIG. 6 is a flowchart depicting a method of manufacturing an improved bicycle chainring assembly, according to aspects of the present teachings.

### DETAILED DESCRIPTION OF THE INVENTION

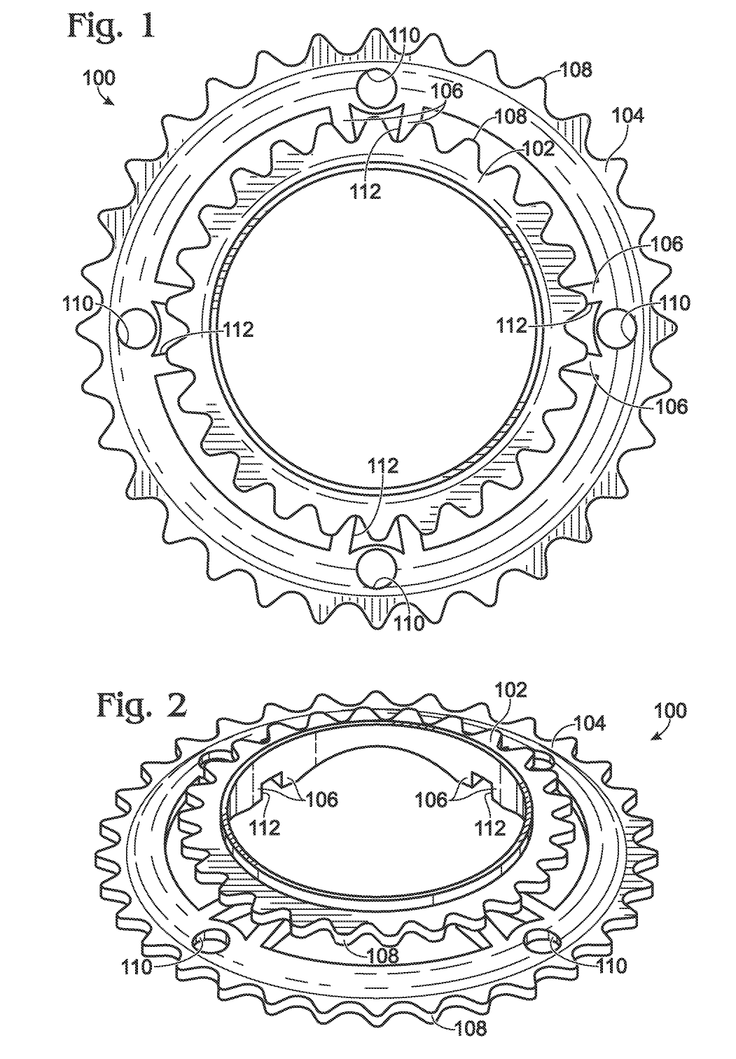

FIG. 1 is a top view depicting one embodiment of an improved bicycle chainring assembly, generally indicated at 100, according to aspects of the present teachings. Chainring assembly 100 includes a first, smaller chainring 102 and a second, larger chainring 104, which are integrally formed and connected through various connection structures 106 (see FIG. 2). Each chainring includes a plurality of teeth 108 for engaging a bicycle chain. A plurality of mounting apertures 110, which may be configured to receive either standard or proprietary crank bolts, are formed in a peripheral portion of larger chainring 104 for connecting assembly 100 to a crankarm. Notches 112 are formed in chainring 104 in the vicinity of apertures 110, and are configured to receive complementary chainring mounting portions of a crankarm.

FIG. 2 depicts an isometric view of chainring assembly 100. As FIG. 2 indicates, connection structures 106 may connect smaller chainring 102 to larger chainring 104 on each side of each mounting aperture 110 and notch 112. Accordingly, chainring assembly 100 may include approximately twice as many connection structures as mounting apertures, resulting in a relatively stiff connection between rings 102 and 104. This is in contrast to conventional chainring assemblies, which typically connect separate chainrings together with the crankarm mounting bolts, resulting in an equal number of connection points as mounting apertures.

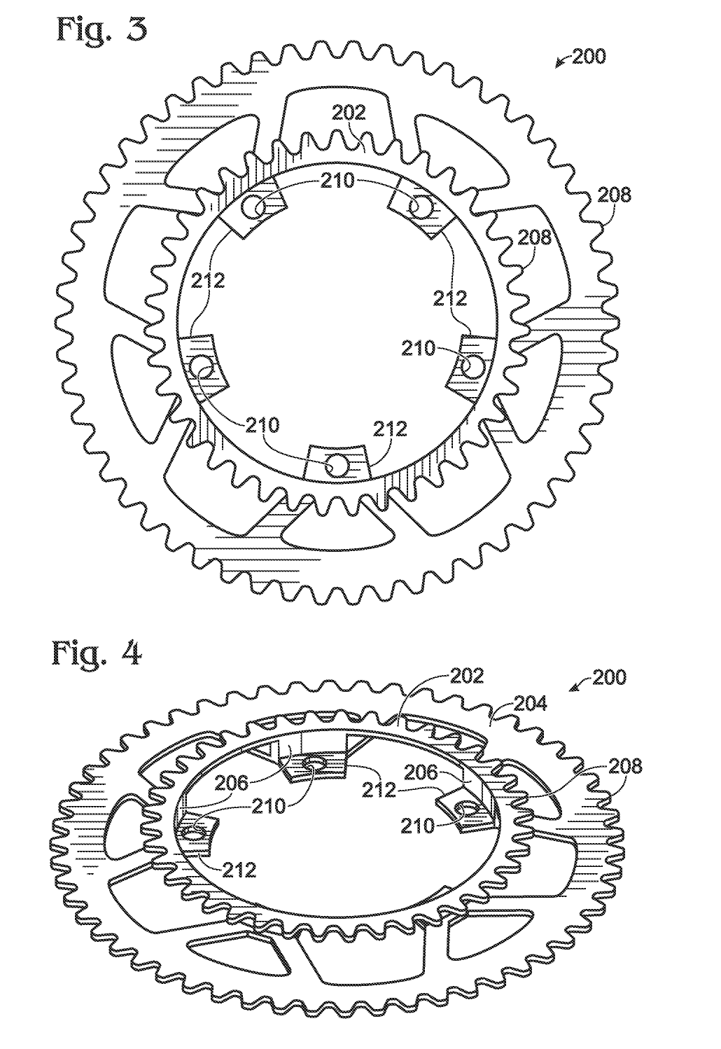

FIG. 3 depicts a top view of another embodiment of an improved bicycle chainring assembly, generally indicated at 200, according to aspects of the present teachings. Chainring assembly 200 is similar in many respects to assembly 100 and includes a first, smaller chainring 202 and a second, larger chainring 204, integrally formed and connected through connection structures 206. Each chainring includes a plurality of teeth 208 for engaging a bicycle chain. A plurality of mounting apertures 210 are provided for connecting assembly 200 to a crankarm. Unlike in assembly 100, however, mounting apertures 210 of assembly 200 are formed in mounting tabs 212 extending from an inner portion of chainring 204, rather than near the outer periphery of the larger chainring. Like notches 112 of chainring assembly 100, mounting tabs 212 of assembly 200 may be configured to receive complementary chainring mounting portions of a crankarm.

FIG. 4 depicts an isometric view of chainring assembly 200, illustrating further details of the assembly and in particular of connection structures 206. As FIG. 4 indicates, connection structures 206 may be formed of ridges of material that connect smaller chainring 202 to larger chainring 204 in continuous bands in the tangential vicinity of each mounting aperture. This may offer improved stiffness of the assembly in comparison to chainring assemblies that include chainrings connected to each other only by a finite number of mounting bolts. The continuous band of connection structures 206 also may be used in conjunction with mounting apertures formed further toward the periphery of the assembly.

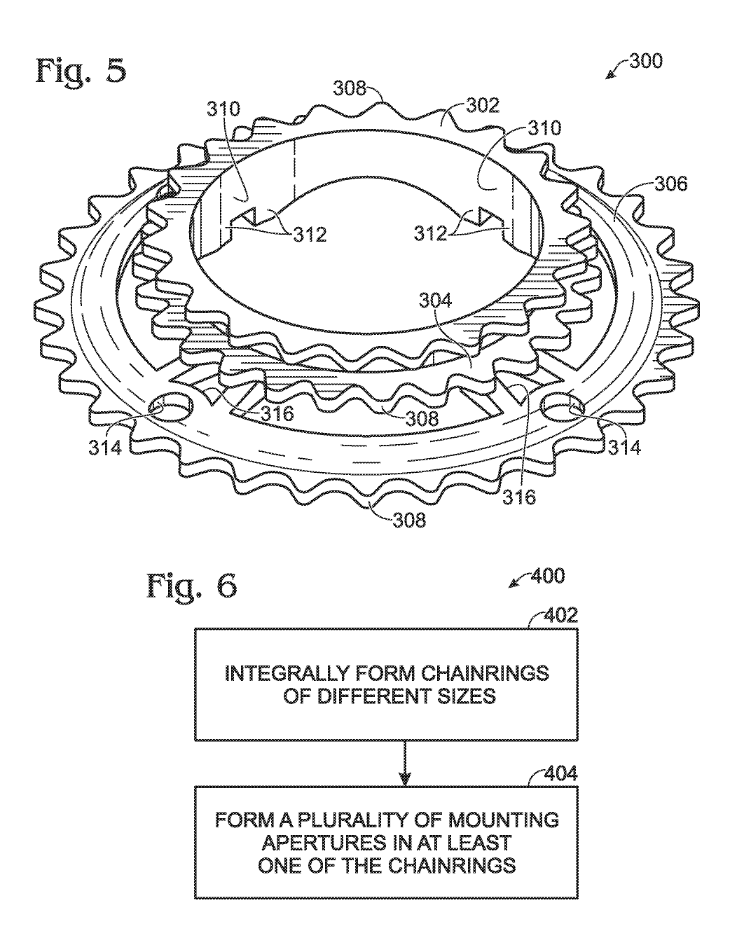

FIG. 5 depicts an isometric view of yet another exemplary embodiment of an integrated chainring assembly, generally indicated at 300, according to aspects of the present teachings. Rather than only two chainrings, assembly 300 includes three integrally formed chainrings 302, 304, and 306 having a smallest, medium and largest size, respectively, each of which includes a plurality of teeth 308 for engaging a bicycle chain. Such three chainring assemblies may be used when a rider wishes to have particularly low gear ratios available, for example on mountain bicycles or road bicycles marketed to beginning riders.

In the embodiment depicted in FIG. 5, ring 302 is connected to ring 304 by a first set of connection structures 310, and ring 304 is connected to ring 306 by a second set of connection structures 312. Connection structures 310 are similar to connection structures 206 of the embodiment shown in FIGS. 3-4, in the sense that connection structures 310 are formed of a continuous ridge of material joining rings 302 and 304. On the other hand, connection structures 312 are similar to connection structures 106 of the embodiment shown in FIGS. 1-2, in the sense that connection structures 312 are formed on either side of a plurality of mounting apertures 314.

In assembly 300, mounting apertures 314 may be configured to receive either industry standard or proprietary crank bolts, and are formed in largest chainring 306 for connecting assembly 300 to a crankarm. Furthermore, notches 316 are formed in chainring 306 in the vicinity of apertures 314, and are configured to receive complementary chainring mounting portions of a crankarm. Alternatively, according to the present teachings, mounting apertures may be formed in any of the rings of an integrated chainring assembly, not just in the largest ring, and notches or other structures may be formed in any portion of an integrated assembly to interface with complementary mounting portions of a crankarm.

As depicted in FIG. 5, the distinction between two separate sets of connection structures is somewhat arbitrary. Alternatively, the chainrings of embodiment 300 may be viewed as connected by a single set of connection structures that includes both a continuous ridge of material 310 and two portions of connecting material 312 formed on other side of an aperture 314 and a notch 316. In addition, the structures that connect the various chainrings may take many discrete, continuous, or semi-continuous forms, and need not lie along a common diameter as depicted in FIG. 5. In some three chainring embodiments, two of the three chainrings may be integrally formed as described above, while the third chainring is attached to the other two by conventional means such as chainring bolts.

FIG. 6 is a flowchart depicting an exemplary method, generally indicated at 400, of manufacturing a bicycle chainring assembly according to aspects of the present teachings. At step 402, at least first and second chainrings of different sizes are integrally formed, with each chainring configured to engage a bicycle chain. As described previously with respect to the embodiments depicted in FIGS. 1-5, according to the present teachings, the chainrings may be integrally formed by casting, forging, CNC machining, or any other suitable technique that results in a one-piece, unitary construction of the chainrings.

Integrally forming a plurality of chainrings in step 402 may include forming various other structures. For example, step 402 may include forming a plurality of connection structures, such as previously described connection structures 106, 206, 310, and/or 312 of FIGS. 1-5, connecting the first chainring and the second chainring. Step 402 also may include forming a plurality of notches in the connection structures, where the notches are configured to receive complementary mounting portions of a bicycle crankarm, or forming a plurality of mounting tabs extending from one of the chainrings. Also as described previously, in some cases three chainrings (rather than just two) may be integrally formed as part of step 402.

At step 404, a plurality of mounting apertures is formed in at least one of the chainrings, where the mounting apertures are configured to receive mounting hardware for connecting the chainrings to a bicycle crankarm. Generally, one of the integrally formed chainrings will have a larger diameter than the other chainring(s), and in some cases the mounting apertures may be formed in a peripheral portion of the largest chainring. When mounting tabs are formed extending from one of the chainrings, mounting apertures may be formed in the mounting tabs.

Integrated chainring assemblies according to the present teachings, including the exemplary configurations illustrated in FIGS. 1-5 and assemblies formed according to the methods described by FIG. 6, may be formed of any suitable materials and by any suitable method. For example, the assemblies may be formed of anodized or non-anodized aluminum, aluminum alloy materials, titanium, scandium, or any other material with desirable properties such as stiffness and relatively light weight. The assemblies may be manufactured by CNC machining, forging, and/or casting, among others.

According to the present teachings, the spacing or offset between adjacent chainrings in an integrated chainring assembly may be chosen for compatibility with existing bicycle shifting systems. Similarly, according to the present teachings, the dimensions, shapes, and spacing between adjacent teeth of the chainrings in an integrated chainring system may be chosen to be compatible with particular types of bicycle chains or with particular drivetrain systems.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. For example, chainring assemblies including two integrated chainrings and a third, non-integrated chainring are within the scope of the present teachings. The subject matter of the inventions contemplated by the present teachings includes all novel and nonobvious combinations and subcombinations of the various elements, features, functions, and/or properties disclosed herein. Inventions embodied in various combinations and subcombinations of features, functions, elements, and/or properties may be claimed in applications claiming priority from this or a related application.

We claim:

1. A bicycle chainring assembly, comprising:
first and second integrally formed chainrings, each configured to engage a bicycle chain;
a plurality of integrally formed connection structures forming a connection between the first chainring and the second chainring; and
a plurality of mounting apertures configured to receive mounting hardware for connecting the chainrings to a bicycle crankarm.

2. The chainring assembly of claim 1, wherein the first chainring has a larger diameter than the second chainring, and wherein the mounting apertures are formed in a peripheral portion of the first chainring.

3. The chainring assembly of claim 1, further comprising a plurality of notches configured to receive complementary mounting portions of a bicycle crankarm.

4. The chainring assembly of claim 1, further comprising a plurality of mounting tabs extending from one of the chainrings, and wherein the mounting apertures are formed in the mounting tabs.

5. The chainring assembly of claim 1, wherein the first and second chainrings are integrally formed by casting.

6. The chainring assembly of claim 1, wherein the first and second chainrings are integrally formed by CNC machining.

7. The chainring assembly of claim 1, wherein the first and second chainrings are integrally formed by forging.

8. The chainring assembly of claim 1, further comprising a third chainring configured to engage a bicycle chain.

9. The chainring assembly of claim 8, wherein the third chainring is integrally formed with the first and second chainrings.

10. A method of manufacturing a bicycle chainring assembly, comprising:
integrally forming at least first and second chainrings, each including a plurality of teeth configured to engage a bicycle chain; and
forming a plurality of mounting apertures in at least one of the chainrings, wherein the mounting apertures are configured to receive mounting hardware for connecting the chainrings to a bicycle crankarm.

11. The method of claim 10, wherein the first chainring has a larger diameter than the second chainring, and wherein the mounting apertures are formed in a peripheral portion of the first chainring.

12. The method of claim 10, wherein integrally forming the first and second chainrings includes forming a plurality of connection structures connecting the first chainring and the second chainring.

13. The method of claim 12, wherein integrally forming the first and second chainrings includes forming a plurality of notches in the connection structures, and wherein the notches are configured to receive complementary mounting portions of a bicycle crankarm.

14. The method of claim 10, wherein integrally forming the first and second chainrings includes forming a plurality of mounting tabs extending from one of the chainrings, and wherein the mounting apertures are formed in the mounting tabs.

15. The method of claim 10, wherein the first and second chainrings are integrally formed by casting.

16. The method of claim 10, wherein the first and second chainrings are integrally formed by CNC machining.

17. The method of claim 10, wherein the first and second chainrings are integrally formed by forging.

18. The method of claim 10, further comprising forming a third chainring configured to engage a bicycle chain.

19. The method of claim 10, wherein the step of integrally forming at least first and second chainrings includes integrally forming first, second and third chainrings.

20. A bicycle chainring assembly, comprising:
first and second integrally formed chainrings, each including a plurality of teeth configured to engage a bicycle chain;
a plurality of integrally formed connection structures forming a connection between the first chainring and the second chainring;
a plurality of integrally formed mounting structures configured to receive complementary mounting portions of a bicycle crankarm; and
a plurality of mounting apertures formed in a larger one of the first and second chainrings and configured to receive chainring bolts for connecting the chainrings to the bicycle crankarm.
